(19) United States
(12) Patent Application Publication
(10) Pub. No.: US 2013/0097482 A1
(43) Pub. Date: Apr. 18, 2013

(54) SEARCH RESULT ENTRY TRUNCATION USING PIXEL-BASED APPROXIMATION

(71) Applicants: Daniel Marantz, Bellevue, WA (US); Keith A. Regier, Kirkland, WA (US); Tejas Nadkarni, Bellevue, WA (US); David D. Ahn, San Francisco, CA (US); Gianluca Donato, Sunnyvale, CA (US)

(72) Inventors: Daniel Marantz, Bellevue, WA (US); Keith A. Regier, Kirkland, WA (US); Tejas Nadkarni, Bellevue, WA (US); David D. Ahn, San Francisco, CA (US); Gianluca Donato, Sunnyvale, CA (US)

(73) Assignee: MICROSOFT CORPORATION, Redmond, WA (US)

(21) Appl. No.: 13/272,252

(22) Filed: Oct. 13, 2011

(51) Int. Cl. G06F 17/00

(52) U.S. Cl. 715/234

(57) ABSTRACT

A presentation-layer algorithm that uses pixel-based character approximations, a feedback loop for detecting the available presentation width, and presentation-layer specific knowledge of the space available for the content in its rendered form, further taking into consideration adjacent content to optimize the presentation of web result title and snippet text.

### BACKGROUND

Text in both a web result title and snippet (e.g., web result paragraph) is currently truncated at generation time based on character counts and expected maximum spaces. The user's available screen space for the text on the browser is not considered during this process, oftentimes incurring wrapping of the content which results in an inordinate amount of content to fit its intended space. Titles and snippets are currently truncated based on pre-set character lengths. Thus, there neither is any accommodation for the actual space available on the browser nor the different widths of characters (e.g., the letter “i” carries the same weight as the letter “w” in terms of length, as only the presence of the character counts in existing implementations).

This leads to an undesirable experience as the search results page becomes ragged with results that are not uniform, thereby leading to a more difficult visual scan pattern for the viewer and trouble parsing content.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a presentation-layer algorithm that uses pixel-based character approximations, a feedback loop for detecting the available presentation width, and presentation-layer specific knowledge of the space available for the content in its rendered form, further taking into consideration adjacent content to optimize the presentation of web result title and snippet text.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system that employs pixel-based approximation for result processing in accordance with the disclosed architecture.

FIG. 3 illustrates the search result for snippet truncation.

FIG. 4 illustrates an example truncation for a snippet.

FIG. 5 illustrates screenshots of non-truncated results and truncated results in accordance with the disclosed architecture.

FIG. 6 illustrates a screenshot of truncation processing with rich elements.

FIG. 7 illustrates a method in accordance with the disclosed architecture.

FIG. 8 illustrates further aspects of the method of FIG. 7.

FIG. 9 illustrates an alternative method.

FIG. 10 illustrates further aspects of the method of FIG. 9.

FIG. 11 illustrates a block diagram of a computing system that executes content truncation in accordance with the disclosed architecture.

### DETAILED DESCRIPTION

The disclosed architecture enables pixel-based approximation for search result content presentation in a web browser. A feedback loop detects the available space on the client's browser to render the text (content). Pixel-based calculations of the text width are performed as the text will appear on the browser. Context-sensitive calculations are employed to predict the amount of space remaining to render the string once the page is assembled and rendered on the client.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

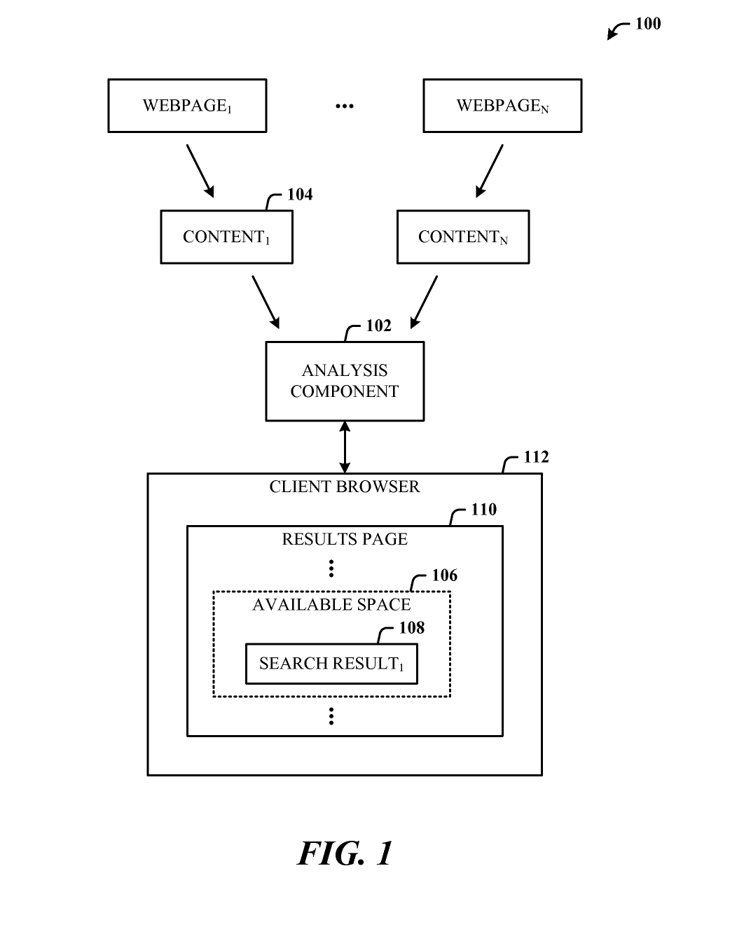

FIG. 1 illustrates a system 100 in accordance with the disclosed architecture. The system 100 includes an analysis component 102 that performs pixel-based character approximation of text characters in content 104 (e.g., text) from a webpage to be presented in available space 106 association with a search result 108 on a results page 110. The analysis component 102 can be a presentation layer (e.g., OSI (open system interconnection) model) algorithm. The analysis component 102 can be server-based. The pixel-based character approximation can be performed using a browser 112 via which the search result 108 is presented. The analysis component 102 performs a context-sensitive calculation to predict the remaining space associated with (e.g., in) the search result 108 to render the text characters when the results page 110 is assembled and rendered on a client.

Note that although represented as the search result 108 within the available space 106, the disclosed architecture applies equally to determining available space to subcomponents of the search result 108. For example, the search result can include a snippet subcomponent that further includes subsnippet subcomponents of content such as text. It can be the case that the available space 106 is determined for the subcomponents (e.g., snippet, subsnippets, etc.) rather than the search result 108 as a whole.

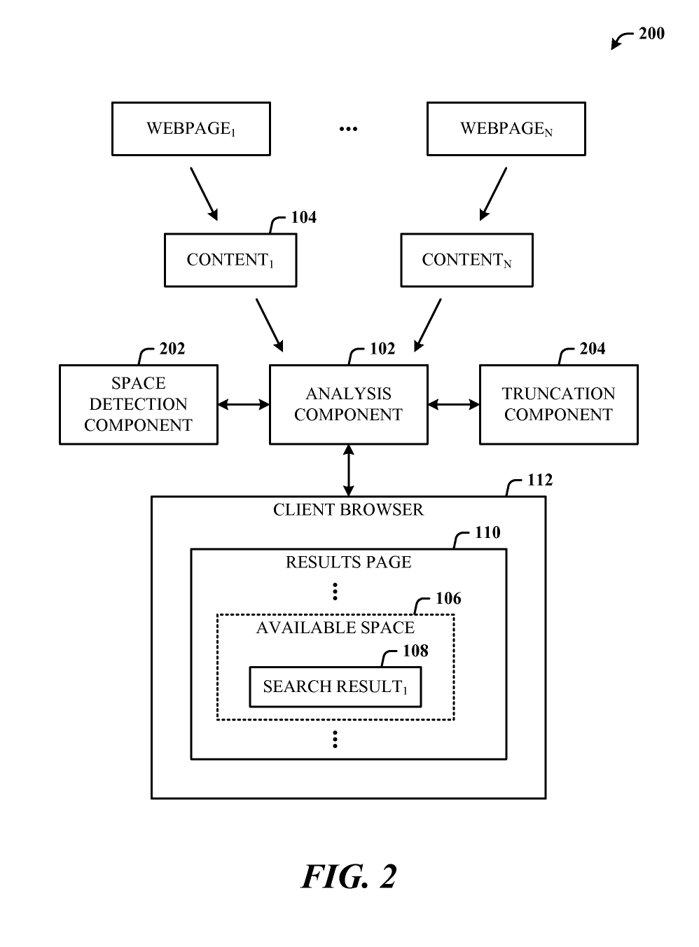

FIG. 2 illustrates an alternative system 200 that employs pixel-based approximation for result processing in accordance with the disclosed architecture. The system 200 can further comprise a space detection component 202 that employs a feedback loop to compute the available space 106 of the search result 108. The system 200 can further comprise a truncation component 204 that truncates a line of text of the search result 108 to fit the available space 106. The truncation component 204 alternately drops tokens from a subsnippet to fit the characters into the available space. The truncation component 204 computes pixel-lengths of the tokens alternatively dropped from a subsnippet to until fit of the characters into the available space 106.

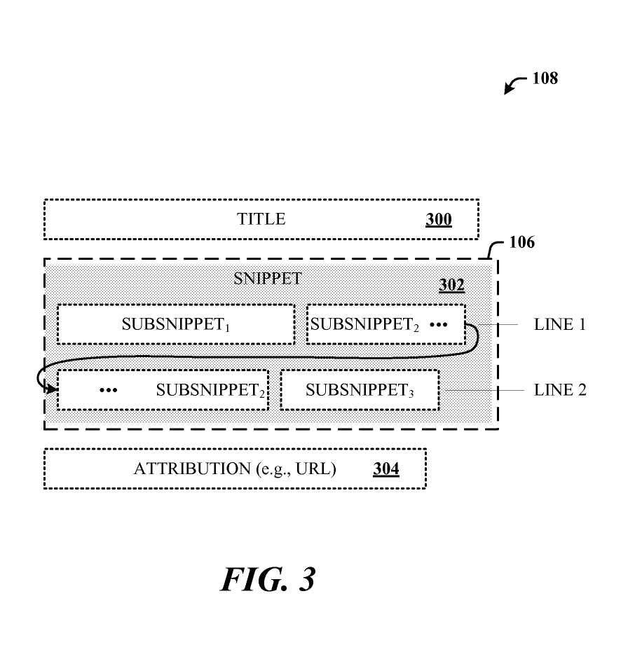

FIG. 3 illustrates the search result 108 for snippet truncation. The search result 108 comprises a title 300, snippet 302 (a set of information from the target webpage (e.g., Webpage₁ of FIG. 1), and related to a query processed by a search engine), and an attribution 304 (e.g., uniform resource locator—URL) to the target webpage. The snippet 302 is shown as the grayed area, which comprises three subsnippets (Subsnippet₁, Subsnippet₂, and Subsnippet₃) on two lines (Line 1 and Line 2). The first line, Line 1, includes the first subsnippet (Subsnippet₁) and part of the second subsnippet (Subsnippet₂), while the second line, Line 2, includes the remaining part of the second subsnippet (Subsnippet₂), and the third subsnippet (Subsnippet₃). In this case, the available space 106 relates to the snippet 302, which right edge typically extends beyond the boundaries set by the title 300 or the attribution 304. The snippet 302 includes the text (e.g., a form of content) obtained from the target webpage, in this case, three sets of text (subsnippets) from the target webpage.

Following is a more detailed description of an implementation of the disclosed algorithm for pixel-based approximation, detecting available space, and context-sensitive calculations.

The architecture employs a feedback loop to detect the available space on the client's browser. The client's browser width can be detected via a javascript function, for example, then stored in a cookie, and returned to a server with the following search request. The server now has the value of the client browser width stored in the cookie for future calculations with that client. Note that the use of cookies is just one way of communicating this information to a server. Other techniques can be employed such as query strings (e.g., embedded in a URL-uniform resource locator), web forms with hidden fields, and HTTP (hypertext transfer protocol) authentication, for example.

The actual width of the text is calculated based on pixel-widths, (Previous solutions assume a maximum number of characters allowed per line (or position on the page) and the same average size for each character (this assumes a monospace font, which is not the case for the type of fonts used on the search results page).)

A lookup table is created offline which stores the actual pixel width of each font size, font face, and font weight (e.g., bold/italic) that is used on the search results page, with a table for each browser. The measurement is made by using the client browser to measure the width of each character and symbol, individually, and then storing the sizes in a table. This ensures the most accurate data, since the measurement is coming from the client browser. Note that different font faces can be employed in different markets, for example.

Separately or in combination therewith, knowledge of horizontal dimensions can be utilized to estimate where a given line of text will wrap. This allows not only the determination of the width of a given piece of text, but the height of the text piece as well. This capability significantly increases the precision of truncation, and enables the performance of similar arrangements while recognizing item height. For example, truncation can be attempted on a piece of text to two lines, determine that the minimum acceptable dimensions are actually three lines in height, and then recognize that in an adjacent column there is room for three lines of content. This furthers a goal of making the optimum use of available space and downloading the right amount of content to fit the available screen real-estate.

In this particular implementation, the algorithm performs truncation of the snippet text using a “round robin” technique to alternately drop keywords from the end of each subsnippet (the snippet 302 is typically composed of 1-3 subsnippet pieces concatenated by ellipses). This technique avoids cutting the subsnippet text (sentence) off midway and effectively reverses how the snippet is created. The truncation is continued until an un-droppable word is encountered (e.g., a bolded term, which is a keyword from the user), or the remaining length of the snippet 302 is less than or equal to the desired length.

In an alternative implementation, right-side truncation can be employed for query independent snippets and titles. Right-side truncation measures the width of the snippet in pixels, noting the pixel widths for individual tokens. The rightmost n tokens are removed so the remaining snippet fits the desired width.

Last-chance-truncation—when all stop-criteria above are met and the snippet still exceeds the desired size, right-side-truncation can be used to trim the end of the snippet of the remaining characters to meet the desired length.

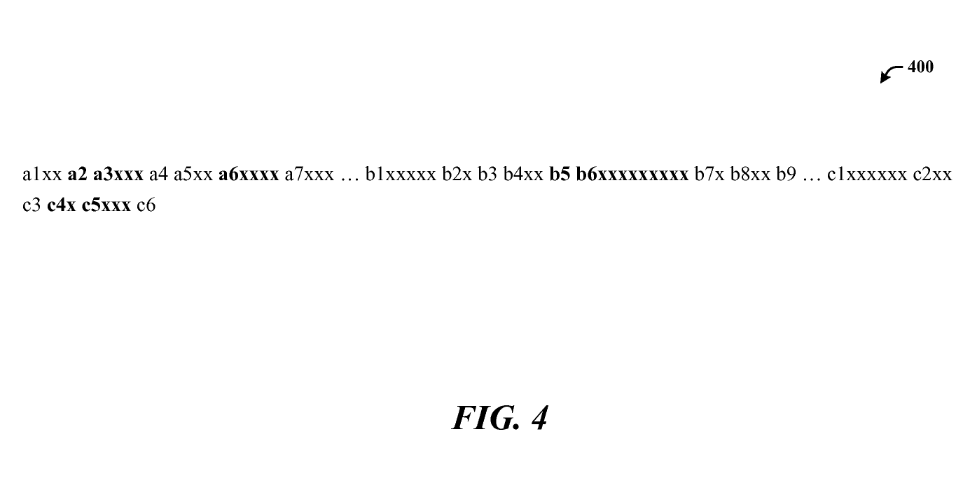

FIG. 4 illustrates an example truncation for a snippet 400. Following are detailed steps for an exemplary “round robin” truncation. First, calculate the number of pixels the returned snippet 302 occupies. The truncation process can then stop, if the number of pixels is less than the desired maximum length for the snippet 302. The pixel width of each token (e.g. a word or a contiguous hit-highlighted set of words) is stored (e.g., in a server). A subsnippet is then selected (e.g., randomly). Assume there are three subsnippets, a, b, and c, in the example. Consider the following example snippet (where a#xxx designates the #th word in subsnippet a) as illustrated. Tokens are removed alternately from the end of the subsnippet and the start of the subsnippet until the threshold pixel-length has been attained. Assume subsnippet “a” was selected. Token a7 is removed first and the resulting length is re-checked.

The order of token removal for the snippet 400 can be: a7, a1, b9, b1, b8, b3, b7, b4, c6, c1, c2, and c3. Bolded tokens mark the edge of the subsnippet where further token dropping does not occur. Thus, remove token a7 to start, and continue to remove tokens and deducting the associated pixel-length from the overall size until the snippet fits the slot (available space).

With respect to context-sensitive calculation of the remaining space on the browser for the truncated line, each line may have an additional element (e.g., image) on it, depending on where the element is rendered. These additional elements may be a time stamp “May 5, 2010” or a related link, for example. The desired width of the truncated text is calculated by knowing the available browser width, and subtracting the width of the elements which are rendered adjacent to the line (and also by using the pixel-based-approximation technique).

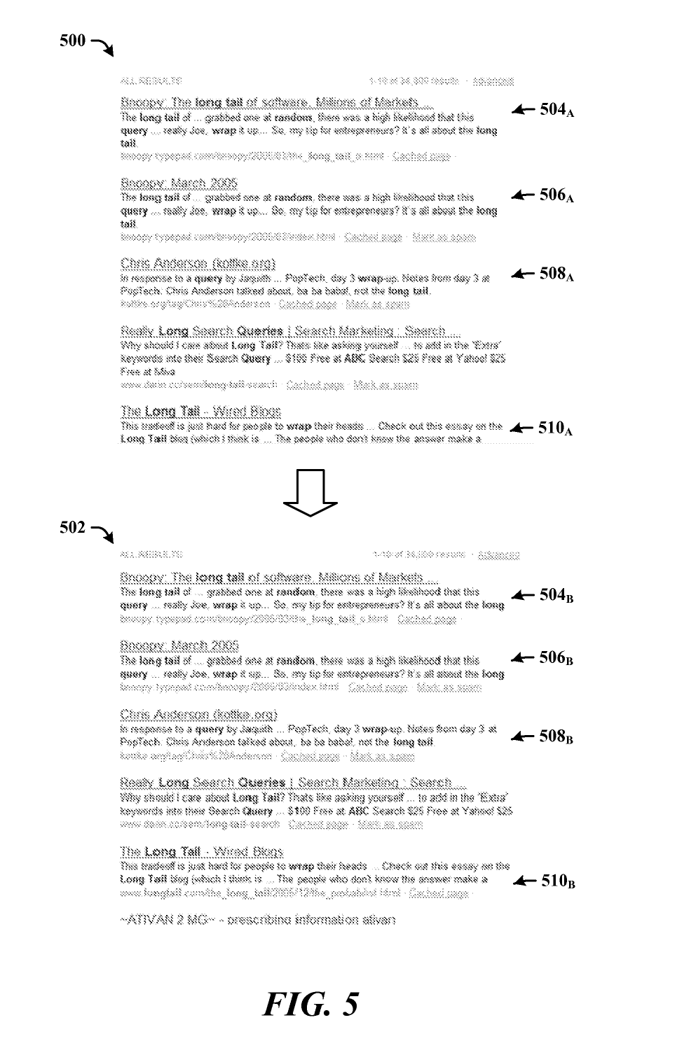

FIG. 5 illustrates screenshots of non-truncated results 500 and truncated results 502 in accordance with the disclosed architecture. A first result entry 504_{A} of the non-truncated results 500 show three lines of subsnippets where the token “tail” wraps to the third line; whereas, the first result entry 504_{B} shows two lines of subsnippets by removing the token “tail”. Similarly, a second result entry 506_{A} of the non-truncated results 500 show three lines of subsnippets where the token “tail” wraps to the third line; whereas, the second result entry 506_{B} shows two lines of subsnippets by removing the token “tail”.

A third result entry 508_{A} of the non-truncated results 500 show two lines of subsnippets. No truncation is needed here, since the content (text) is within the desired pixel length. Thus, the third result entry 508_{B} of the truncated results 502 is the same as third result entry 508_{A}. Moreover, since the wraps have been optimized, the truncated results 502 also show that a bottom result entry 510_{A} of the non-truncated results 500 now is able to present the URL line, as shown in the bottom result entry 510_{B} of the truncated results 502.

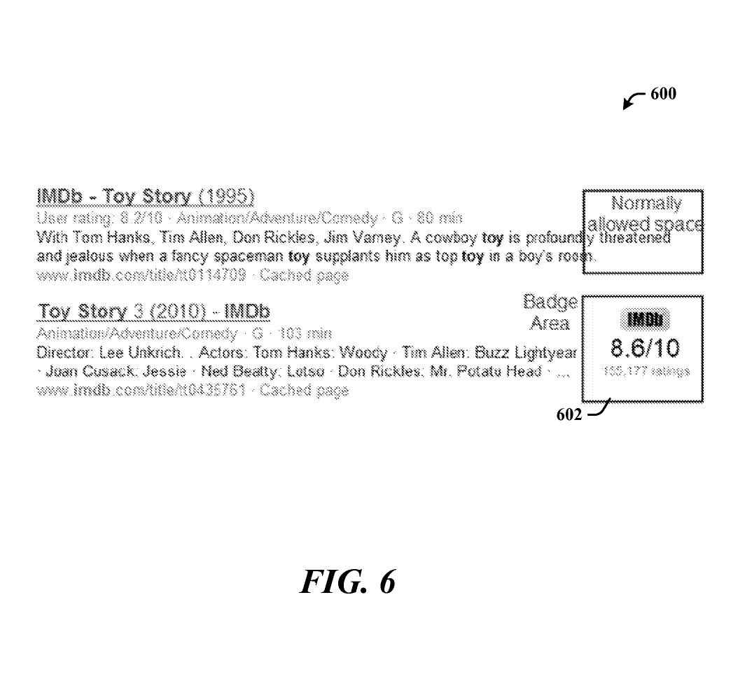

FIG. 6 illustrates a screenshot 600 of truncation processing with a rich element 602. The method can adjust the truncation widths to take into account the remaining allowable space for the snippet after space in the entry was displaced by rich elements. For example, consider the utilization of badges (the rich element 602), which are predefined regions of content in a search result entry. The pixel-based truncation is also used in conjunction with a layout scheme that has these pre-defined regions and a list of elements which may appear in those regions. Based on the elements available at render-time (which compete for space), and the pixel-space left to render on the actual client (after the space has been allotted for the richer optional elements), the architecture adjusts the space available for the snippet to allow for the space occupied by the rich elements.

In one implementation, the badges can approximate areas of one hundred pixels on the entry, which reduces the width available for the snippet. The screenshot 600 compares two entries: a top entry without a rich element, and a bottom entry with a rich element (the “Badge Area”). With the “Badge area” being present, the layout model adjusts the size of the allowable width for the snippet text to accommodate the text on two lines of a shorter width.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

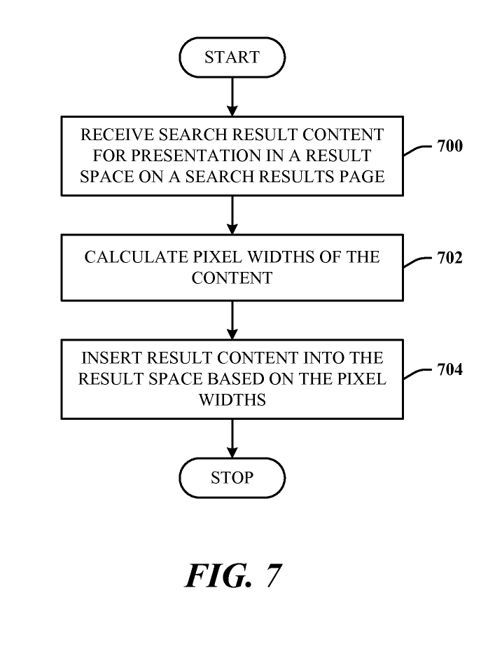

FIG. 7 illustrates a method in accordance with the disclosed architecture. At 700, search result content (e.g., text) is received (in response to a query) for presentation in a result space on a search results page. At 702, pixel widths of the content are calculated. At 704, the result content is inserted into the result space based on the pixel widths.

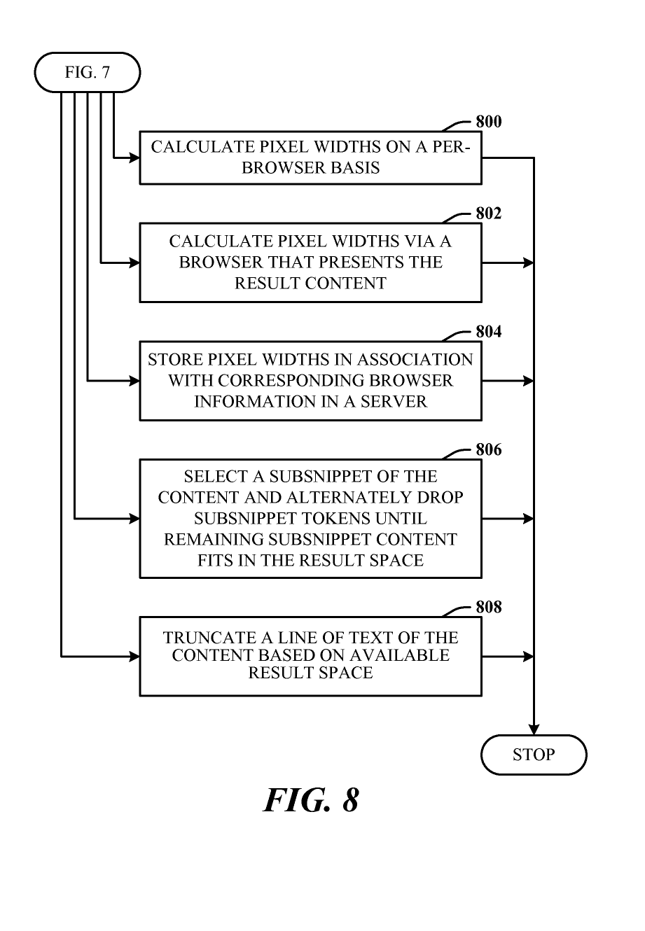

FIG. 8 illustrates further aspects of the method of FIG. 7. Note that the flow indicates that each block can represent a step that can be included, separately or in combination with other blocks, as additional aspects of the method represented by the flow chart of FIG. 7. At 800, the pixel widths are calculated on a per-browser basis. At 802, the pixel widths are calculated via a browser that presents the result content. At 804, the pixel widths are stored in association with corresponding browser information in a server. At 806, a subsnippet of the content is selected and subsnippet tokens are alternately dropped until remaining subsnippet content fits in the result space. At 808, a line of text of the content is truncated based on available result space.

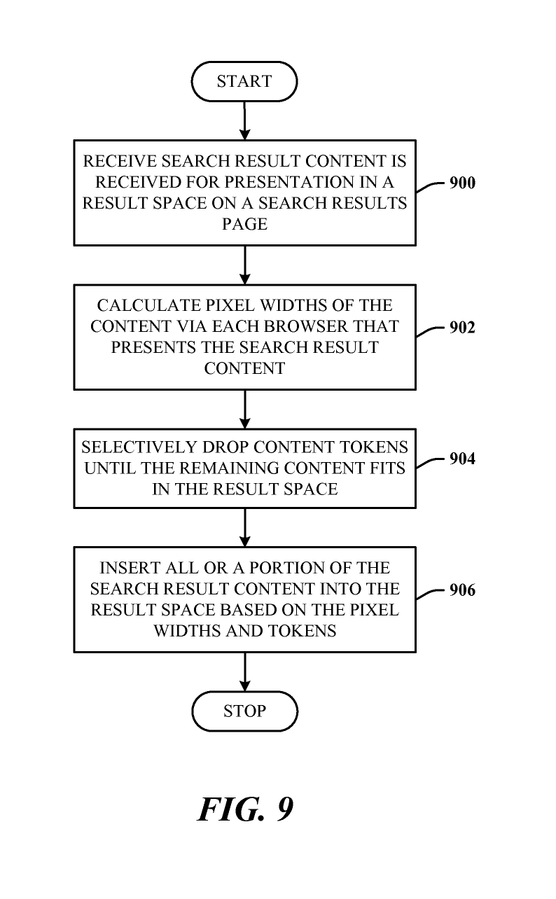

FIG. 9 illustrates an alternative method. At 900, search result content is received for presentation in a result space on a search results page. At 902, pixel widths of the content are calculated via each browser that presents the search result content. At 904, content tokens are selectively dropped until the remaining content fits in the result space. At 906, all or a portion of the search result content is inserted into the result space based on the pixel widths and tokens.

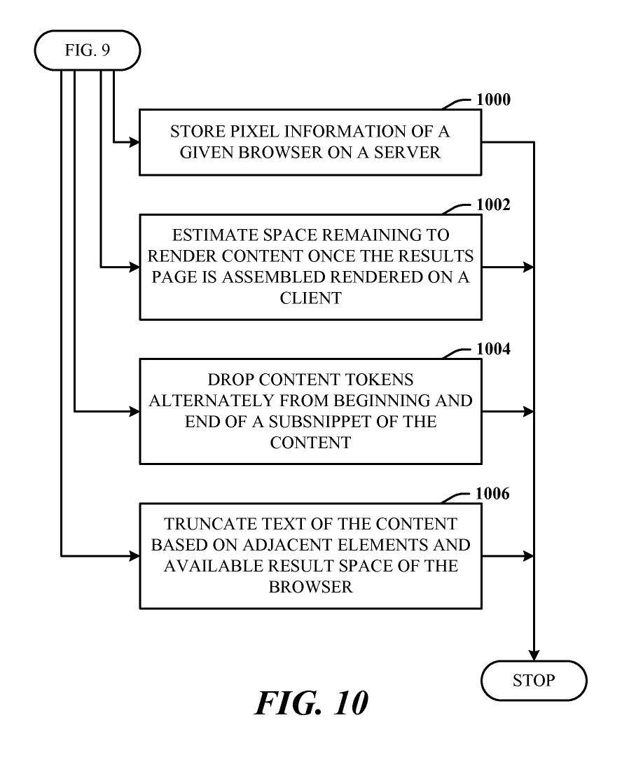

FIG. 10 illustrates further aspects of the method of FIG. 9. Note that the flow indicates that each block can represent a step that can be included, separately or in combination with other blocks, as additional aspects of the method represented by the flow chart of FIG. 9. At 1000, pixel information of a given browser is stored on a server. At 1002, space remaining is estimated to render content once the results page is assembled rendered on a client. At 1004, content tokens are dropped alternately from beginning and end of a subsnippet of the content. At 1006, text of the content is truncated based on adjacent elements and available result space of the browser.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

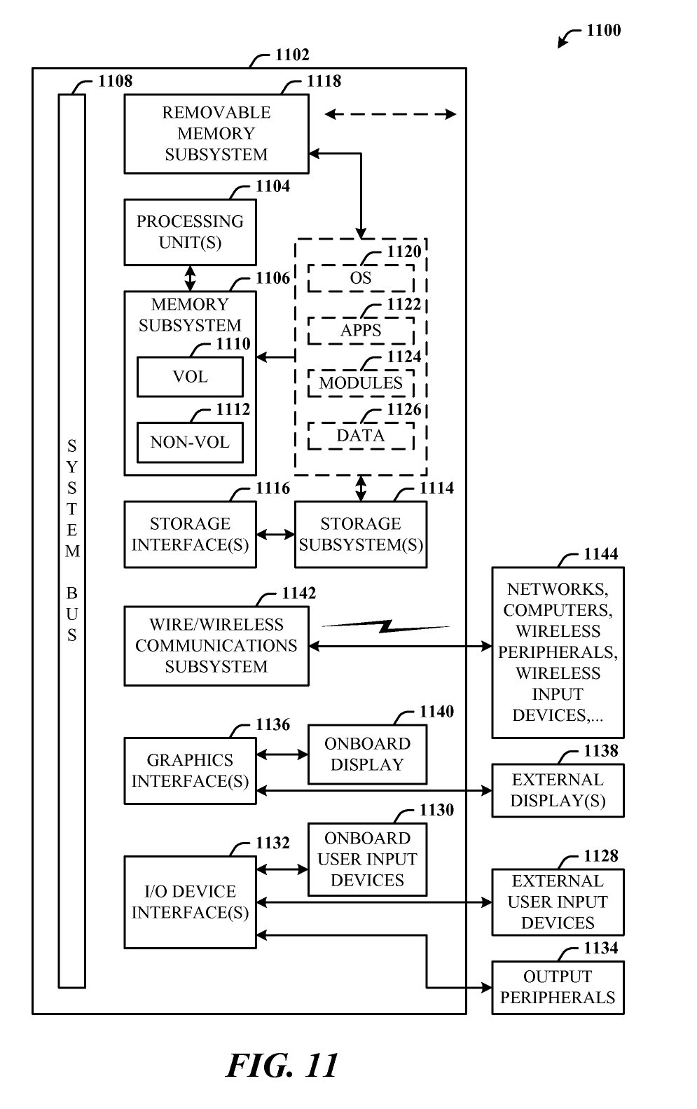

Referring now to FIG. 11, there is illustrated a block diagram of a computing system 1100 that executes content truncation in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 11 and the following description are intended to provide a brief, general description of the suitable computing system 1100 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1100 for implementing various aspects includes the computer 1102 having processing unit(s) 1104, a computer-readable storage such as a system memory 1106, and a system bus 1108. The processing unit(s) 1104 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1106 can include computer-readable storage (physical storage media) such as a volatile (VOL) memory 1110 (e.g., random access memory (RAM)) and non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the system memory 1106 to the processing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes machine readable storage subsystem(s) 1114 and storage interface(s) 1116 for interfacing the storage subsystem(s) 1114 to the system bus 1108 and other desired computer components. The storage subsystem(s) 1114 (physical storage media) can include one or more of a hard disk drive (HDD), a magnetic floppy disk drive (FDD), and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a machine readable and removable memory subsystem 1118 (e.g., flash drive form factor technology), and/or the storage subsystem(s) 1114 (e.g., optical, magnetic, solid state), including an operating system 1120, one or more application programs 1122, other program modules 1124, and program data 1126.

The operating system 1120, one or more application programs 1122, other program modules 1124, and/or program data 1126 can include entities and components of the system 100 of FIG. 1, entities and components of the system 200 of FIG. 2, the snippet truncation of FIG. 3, the snippet truncation of FIGS. 4-6, and the methods represented by the flowcharts of FIGS. 7-10, for example.

Generally, programs include routines, methods, data structures, other software components, etc., that perform particular tasks or implement particular abstract data types. All or portions of the operating system 1120, applications 1122, modules 1124, and/or data 1126 can also be cached in memory such as the volatile memory 1110, for example. It is to be appreciated that the disclosed architecture can be implemented with various commercially available operating systems or combinations of operating systems (e.g., as virtual machines).

The storage subsystem(s) 1114 and memory subsystems (1106 and 1118) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, no that the instructions appear collectively on the one or more computer-readable storage media, regardless of whether of the instructions are on the same media.

Computer readable media can be any available media that can be accessed by the computer 1102 and includes volatile and non-volatile internal and/or external media that is removable or non-removable. For the computer 1102, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1102, programs, and data using external user input devices 1128 such as a keyboard and a mouse. Other external user input devices 1128 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1102, programs, and data using onboard user input devices 1130 such a touchpad, microphone, keyboard, etc., where the computer 1102 is a portable computer, for example. These and other input devices are connected to the processing unit(s) 1104 through input/output (I/O) device interface(s) 1132 via the system bus 1108, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1132 also facilitate the use of output peripherals 1134 such as printers, audio devices, camera devices, and so on, such as a sound card and/or onboard audio processing capability.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP-based) using logical connections via a wired/wireless communications subsystem 1142 to one or more networks and/or other computers. The other computers can include workstations, servers, routers, personal computers, microprocessor-based entertainment appliances, peer devices or other common network nodes, and typically include many or all of the elements described relative to the computer 1102. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wired/wireless communication subsystem 1142 (e.g., a network interface adapter, onboard transceiver subsystem, etc.) to communicate with wired/wireless networks, wired/wireless printers, wired/wireless input devices 1144, and so on. The computer 1102 can include a modem or other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described, above includes examples of the disclosed architecture. It is, of course, not possible to describe every conceivable combination of components and/or methodologies, but one of ordinary skill in the art may recognize that many further combinations and permutations are possible. Accordingly, the novel architecture is intended, to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system, comprising:
an analysis component that performs pixel-based character approximation of text characters to be presented in available space associated with a search result on a results page; and
a processor that executes computer-executable instructions associated with at least the analysis component.

2. The system of claim 1, wherein the analysis component is a presentation layer algorithm.

3. The system of claim 1, wherein the pixel-based character approximation is performed using a browser via which the search result is presented.

4. The system of claim 1, further comprising a space detection component that employs a feedback loop to compute the available space of the search result.

5. The system of claim 1, wherein the analysis component performs a context-sensitive calculation to predict remaining space in the search result to render the text characters when the results page is assembled and rendered on a client.

6. The system of claim 1, further comprising a truncation component that truncates a line of text of the search result to fit the available space.

7. The system of claim 6, wherein the truncation component alternatively drops tokens from subsnippet to fit the characters into the available space.

8. The system of claim 7, wherein the truncation component computes pixel-lengths of the tokens alternatively dropped from a subsnippet to until fit of the characters into the available space.

9. The system of claim 1, wherein the analysis component is server-based.

10. A computer-implemented method, comprising acts of:
receiving search result content for presentation in a result space on a search results page;
calculating pixel widths of the content;
inserting result content into the result space based on the pixel widths; and
utilizing a processor that executes instructions stored in memory to perform at least one of the acts of receiving, calculating, or inserting.

11. The method of claim 10, further comprising calculating the pixel widths on a per-browser basis.

12. The method of claim 10, further comprising calculating the pixel widths via a browser that presents the result content.

13. The method of claim 10, further comprising storing the pixel widths in association with corresponding browser information in a server.

14. The method of claim 10, further comprising selecting a subsnippet of the content and alternately dropping subsnippet tokens until remaining subsnippet content fits in the result space.

15. The method of claim 10, further comprising truncating a line of text of the content based on available result space.

16. A computer-implemented method, comprising acts of:
receiving search result content for presentation in a result space on a search results page;
calculating pixel widths of the content via each browser that presents the search result content;
selectively dropping content tokens until the remaining content fits in the rest space;
inserting all or a portion of the search result content into the result space based on the pixel widths and tokens; and
utilizing a processor that executes instructions stored in memory to perform at least one of the acts of receiving, dropping, calculating, or inserting.

17. The method of claim 16, further comprising storing pixel information of a given browser on a server.

18. The method of claim 16, further comprising estimating space remaining to render content once the results page is assembled rendered on a client.

19. The method of claim 16, further comprising dropping content tokens alternately from beginning and end of a subsnippet of the content.

20. The method of claim 16, further comprising truncating text of the content based on adjacent elements and available result space of the browser.
